(19) United States
(12) Patent Application Publication
(10) Pub. No.: US 2024/0262701 A1
(43) Pub. Date: Aug. 8, 2024

(54) RECYCLE CONTENT AMMONIA

(71) Applicant: Eastman Chemical Company, Kingsport, TN (US)

(72) Inventors: Daryl Bitting, Longview, TX (US); David Eugene Slivensky, Tatum, TX (US); Xianchun Wu, Longview, TX (US)

(73) Assignee: Eastman Chemical Company, Kingsport, TN (US)

(21) Appl. No.: 18/567,259

(22) PCT Filed: Jun. 1, 2022
(86) PCT No.: PCT/US2022/031718

§ 371 Date: Dec. 5, 2023

Related U.S. Application Data
(60) Provisional application No. 63/202,447, filed on Jun. 11, 2021.

(51) Int. Cl. C01C 1/04; C01B 3/36; C01B 3/38; C01B 3/48; C10J 3/66

(52) U.S. Cl. CPC C01C 1/0405; C01B 3/36; C01B 3/382; C01B 3/48; C10J 3/66; C01B 2203/0233; C01B 2203/025; C01B 2203/0283; C01B 2203/068; C01B 2203/1241; C10J 2300/0946

(57) ABSTRACT

A process for making recycle content ammonia by reacting hydrogen with nitrogen. At least a portion of the hydrogen is obtained directly or indirectly by molecular reforming a mixed plastic waste or pyrolysis product feedstock. The molecular reforming can be a steam reforming process or a partial oxidation process, such as a partial oxidation gasifier, to generate the syngas used as a source of hydrogen. The recycle content associated with the ammonia can be obtained from the mixed plastic waste, the recycle content in the pyrolysis product, such as pyoil or pygas, or the recycle content in the syngas or the purified hydrogen stream from the syngas.

### BACKGROUND

There is a well-known global issue with waste disposal, particularly of large volume consumer products such as size reduced MPW, size reduced MPW, MPW and other polymers that are not considered biodegradable within acceptable temporal limits. There is a public desire to incorporate these types of wastes into new products through recycling, reuse, or otherwise reducing the amount of waste in circulation or in landfills.

Much of the recycling effort has historically focused on mechanical recycling, but those technologies are limited to the processing and production of polymers. We desire to employ a method for introducing a recycle content into liquid chemical compound streams, and specifically ammonia that includes recycling post-consumer or post-industrial MPW back to a molecular form suitable for making ammonia, and to make this on a commercial scale in a consistent and reliable fashion. Thus, there exists a need for a commercial process to produce recycled content ammonia.

### SUMMARY

We have discovered a method to incorporate recycle content into ammonia. There is now provided a process for making recycle content ammonia comprising reacting hydrogen with nitrogen, wherein at least a portion of said hydrogen is obtained directly or indirectly by molecular reforming of a feedstock comprising mixed plastic waste (“MPW”), a pyrolysis product, or a combination thereof.

There is also provided a stream of hydrogen and a recycle content certificate.

There is also provided a quantity of ammonia and a recycle content certificate.

There is also provided a use of a recycle content hydrogen stream to make ammonia.

There is also provided a use of a MPW stream or a pyrolysis product to make ammonia.

### DETAILED DESCRIPTION

Unless otherwise stated, reference the weight of the feedstock composition or stream includes all solids, and if present liquids, fed to the gasifier, and unless otherwise stated, does not include the weight of any gases in the feedstock composition as fed to the injector or gasifier. A composition or a stream are used interchangeably.

The process for making recycle content ammonia comprising reacting hydrogen with nitrogen, wherein at least a portion of said hydrogen is obtained directly or indirectly by molecular reforming of a feedstock comprising mixed plastic waste (“MPW”), a pyrolysis product, or a combination thereof. The MPW can be in solid or liquid form.

As used herein, the terms “pyrolysis oil” or “r-pyoil” refers to a composition obtained from pyrolysis that is liquid at 25° C. and 1 atm. The r-pyoil is made using MPW as a feedstock.

The molecular reforming can be a hydrocarbon steam reforming process or a partial oxidation process. Each one of these processes can start with a feedstock of MPW or a pyrolysis product, although depending on the process, these feedstocks may have to be processed to a form suitable and adapted for each type of molecular reforming process.

R-pyrolysis products include r-pyoil and/or r-pygas. R-pyrolysis products are made from heating a carbonaceous feed without oxygen in a reactor at a temperature of more than 400° C., and at least a portion of the carbonaceous feed includes MPW. The pyrolysis system includes a MPW which can be in the form of solid particles, such as chips, flakes, or a powder, or in the form of chunks, shredded, ribboned, or otherwise size reduced from its post-consumer form. Although any MPW stream can be a feedstock, an exemplary stream can comprise, consist essentially of, or consist of high density polyethylene, low density polyethylene, polypropylene, other polyolefins, polystyrene, polyvinyl chloride (PVC), polyvinylidene chloride (PVDC), polyethylene terephthalate, polyamides, poly(methyl methacrylate), polytetrafluoroethylene, or combinations thereof.

In an embodiment or in combination with any of the embodiments mentioned herein, the MPW feed can comprise at least 5, or at least 10, or at least 15, or at least 20, or at least 25, or at least 30, or at least 35, or at least 40, or at least 45, or at least 50, or at least 55, or at least 60, or at least 65, or at least 70, or at least 75, or at least 80, or at least 85, or at least 90, or at least 95, or at least 99, in each case weight percent of at least one, two, three, or four different kinds of waste plastic. The MPW feed to a pretreatment unit and/or the pyrolysis reactor can comprise at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, or at least 99, in each case weight percent of high density polyethylene, low density polyethylene, polypropylene, or combinations thereof.

In an embodiment or in combination with any of the embodiments mentioned herein, no single component makes up more than 80, 75, 70, 65, 60, 55, 50, 45, 40, 35, 30, or 25 percent of the MPW. The feedstock to the pyrolysis reactor can comprise not more than 50 wt. %, or not more than 45, 40, 35, 30, 25, 20, 15, 10, 5, or 1 wt. % biomass, such as wood, cellulose, algae.

The solid waste plastic feed can be supplied to a feedstock pretreatment unit where they may undergo a number of pretreatments to facilitate the subsequent pyrolysis reaction and/or enrich the resulting r-pyoil. Such pretreatments may include, for example, washing, mechanical agitation, flotation, size reduction, separation, dehalogenation or any combination thereof. In an embodiment or in combination with any of the embodiments mentioned herein, the introduced plastic waste may be subjected to mechanical agitation or subjected to size reduction operations to reduce the particle size of the plastic waste. Such mechanical agitation can be supplied by any mixing, shearing, or grinding device known in the art which may reduce the average particle size of the introduced plastics by at least 10, or at least 25, or at least 50, or at least 75, in each case percent. The MPW may be shredded, In an embodiment or in combination with any of the embodiments mentioned herein, the feedstock pretreatment unit 114 may comprise a shredding unit configured to at least partially shred the plastic waste into a shredded waste. The feedstock pretreatment unit may also have a separator unit configured to separate the plastic waste or the shredded plastic waste from a shredding unit into a waste plastic feedstock for the pyrolysis reactor and an undesirable waste stream that will not be subjected to pyrolysis. The separator unit may comprise a filter, a cyclone separator, a fractionator, a floatation tank, or combinations thereof. In an embodiment or in combination with any of the embodiments mentioned herein, the pretreatment unit may comprise a shredding unit and a separator unit.

While in the pyrolysis reactor, at least a portion of the plastic feed may be subjected to a pyrolysis reaction that produces a pyrolysis product comprising a pyrolysis oil (e.g., r-pyoil) and a pyrolysis gas (e.g., r-pyrolysis gas). The pyrolysis reactor can be, for example, an extruder, a tubular reactor, a tank, a stirred tank reactor, a riser reactor, a fixed bed reactor, a fluidized bed reactor, a rotary kiln, a vacuum reactor, a microwave reactor, an ultrasonic or supersonic reactor, or an autoclave, a film reactor, or a combination of these reactors.

Generally, pyrolysis is a process that involves the chemical and thermal decomposition of the introduced feed. Although all pyrolysis processes may be generally characterized by a reaction environment that is substantially free of oxygen, pyrolysis processes may be further defined, for example, by the pyrolysis reaction temperature within the reactor, the residence time in the pyrolysis reactor, the reactor type, the pressure within the pyrolysis reactor, and the presence or absence of pyrolysis catalysts.

In an embodiment or in combination with any of the embodiments mentioned herein, the pyrolysis reaction can involve heating and converting the plastic feed in an atmosphere that is substantially free of oxygen or in an atmosphere that contains less oxygen relative to ambient air. In an embodiment or in combination with any of the embodiments mentioned herein, the atmosphere within the pyrolysis reactor may comprise not more than 5, or not more than 4, or not more than 3, or not more than 2, or not more than 1, or not more than 0.5, in each case weight percent of oxygen gas.

The pyrolysis process may be carried out in the presence of a lift gas and/or a feed gas such as nitrogen, carbon dioxide, steam, natural gas, pyrolysis gas or pyrolysis dry gas. The pyrolysis process can be carried out in the presence of a reducing gas, such as hydrogen and/or carbon monoxide.

The temperature in the pyrolysis reactor can be adjusted to as to facilitate the production of certain end products. The pyrolysis temperature in the pyrolysis reactor can range from 325 to 1,100° C., 350 to 900° C., 350 to 700° C., 350 to 550° C., 350 to 475° C., 500 to 1,100° C., 600 to 1,100° C., or 650 to 1,000° C. The residence times of the pyrolysis reaction can from 0.1 to 10 seconds, 0.5 to 10 seconds, 30 minutes to 4 hours, or 30 minutes to 3 hours, or 1 hour to 3 hours, or 1 hour to 2 hours. The pressure within the pyrolysis reactor can be maintained at a pressure of about atmospheric pressure or within the range of 0.1 to 100 bar, or 0.1 to 60 bar, or 0.1 to 30 bar, or 0.1 to 10 bar, or 1.5 bar, 0.2 to 1.5 bar, or 0.3 to 1.1 bar.

The pyrolysis process can also be catalytic, and the catalyst can comprise: (i) a solid acid, such as a zeolite (e.g., ZSM-5, Mordenite, Beta, Ferrierite, and/or zeolite-Y); (ii) a super acid, such as sulfonated, phosphated, or fluorinated forms of zirconia, titania, alumina, silica-alumina, and/or clays; (iii) a solid base, such as metal oxides, mixed metal oxides, metal hydroxides, and/or metal carbonates, particularly those of alkali metals, alkaline earth metals, transition metals, and/or rare earth metals; (iv) hydrotalcite and other clays; (v) a metal hydride, particularly those of alkali metals, alkaline earth metals, transition metals, and/or rare earth metals; (vi) an alumina and/or a silica-alumina; (vii) a homogeneous catalyst, such as a Lewis acid, a metal tetrachloroaluminate, or an organic ionic liquid; (viii) activated carbon; or (ix) combinations thereof. The catalyst can comprise platinum, nickel, palladium, ruthenium, rhodium, nickel, mordenite, or a combination thereof. However, the pyrolysis reaction in the pyrolysis reactor may occur in the substantial absence of a pyrolysis catalyst, at a temperature in the range of 350 to 550° C., at a pressure ranging from 0.1 to 60 bar, and at a residence time of 0.2 seconds to 4 hours, or 0.5 hours to 3 hours.

The pyrolysis effluent exiting the pyrolysis reactor generally comprises pyrolysis gas, pyrolysis vapors, and residual solids. The vapors produced during the pyrolysis reaction may interchangeably be referred to as a “pyrolysis oil,” which refers to the vapors when condensed into their liquid state. The solids in the pyrolysis effluent may comprise particles of char, ash, unconverted plastic solids, other unconverted solids from the feedstock, and/or spent catalyst (if a catalyst is utilized). The pyrolysis effluent may comprise at least 20, or at least 25, or at least 30, or at least 40, or at least 45, or at least 50, or at least 55, or at least 60, or at least 65, or at least 70, or at least 75, or at least or at least 80, in each case weight percent of the pyrolysis vapors, which may be subsequently condensed into the resulting pyrolysis oil (e.g., r-pyoil). The pyrolysis effluent may comprise in the range of 20 to 99 weight percent, 40 to 90 weight percent, or 55 to 90 weight percent pyrolysis vapors. The pyrolysis effluent may comprise at least 1, or at least 5, or at least 6, or at least 7, or at least 8, or at least 9, or at least 10, or at least 11, or at least 12, in each case weight percent of the pyrolysis gas (e.g., r-pyrolysis gas). As used herein, a “pyrolysis gas” refers to a composition that is produced via pyrolysis and is a gas at standard temperature and pressure (STP). The pyrolysis effluent may comprise 1 to 90 weight percent, or 5 to 60 weight percent, or 10 to 60 weight percent, or 10 to 30 weight percent, or 5 to 30 weight percent pyrolysis gas that can be removed from the system and used as a feedstock to molecular reforming. The pyrolysis gas can be compressed into a liquid form or fed as gas in gaseous communication with a molecular reforming reactor or conditioning system.

The effluent from the pyrolysis reactor can be introduced into a solids separator capable of separating solids from gas and vapors such as, for example, a cyclone separator or a gas filter or combination thereof. The remaining gas and vapor conversion products from the solids separator may be introduced into a fractionator where at least a portion of the pyrolysis oil vapors may be separated from the gas to thereby form a pygas product stream and a pyrolysis oil vapor. Suitable systems to be used as the fractionator may include, for example, a distillation column, a membrane separation unit, a quench tower, a condenser, or any other known separation unit known in the art. At least a portion of the pyrolysis oil vapor stream may be introduced into a quench unit in order to at least partially quench the pyrolysis vapors into their liquid form (i.e., the pyrolysis oil). The quench unit may comprise any suitable quench system known in the art, such as a quench tower. The resulting liquid pyoil stream may be removed from the system as a pyrolysis product. The pyoil can be a feedstock to the molecular reforming process.

Any other suitable pyrolysis systems can be employed to make pyrolysis products. For example, the pyrolysis system may contain a first pyrolysis zone and a second pyrolysis zone in order to more effectively remove undesirable halogen-containing compounds or plastics that may be present in the initial plastic feedstock being introduced into the system. The first pyrolysis zone and the second pyrolysis zone may be located in the same reactor or may be located within separate reactors. The first pyrolysis zone can operate at lower temperatures relative to the second pyrolysis zone. For example, the first pyrolysis zone may operate at temperatures in the range of 150° C. to 400° C., 175° C. to 375° C., or 200° C. to 350° C. The first pyrolysis zone may at least partially melt undesirable halogen-containing plastics, such as PVC, but leave the more desirable plastics in solid or semi-solid form (e.g., polyethylene). Thus, the first pyrolysis zone 46 may yield a partially-melted plastic feedstock and halogen-containing byproduct gases (e.g., HCl). The first pyrolysis zone may comprise an extruder, a conveyer, or a rotary kiln.

The pyrolysis system may produce a r-pyoil and r-pygas that may be directly used in various downstream molecular reforming systems described herein. In one embodiment, the pyrolysis products are not subjected to hydrogenation and/or hydrotreatment prior to introducing into a molecular reforming reaction zone.

The pyrolysis oil may predominantly comprise hydrocarbons having from 4 to 30 carbon atoms per molecule (e.g., C4 to C30 hydrocarbons). The pyrolysis oil fed to molecular reforming may have a C4-C30 hydrocarbon content of at least 55, or at least 60, or at least 65, or at least 70, or at least 75, or at least 80, or at least 85, or at least 90, or at least 95, or at least 98, or at least 99, or 100, in each case weight percent based on the weight of the pyrolysis oil, or based on the weight of all recycle content feedstocks fed to a molecular reforming reaction zone, or based on the weight of all biomass and recycle content feedstocks fed to a molecular reforming reaction zone. The pyrolysis oil fed to the furnace can predominantly (more than 50 wt. %) comprise C5-C25, C5-C22, C5-C20, C6 to C18, C6 to C16, C6 to C14, or C6 to C12 or may comprise at least about 55, or at least 60, or at least 65, or at least 70, or at least 75, or at least 80, or at least 85, or at least 90, or at least 95, in each case weight percent of C5-C25, C5-C22, or C5-C20, C6 to C18, C6 to C16, C6 to C14, or C6 to C12 hydrocarbons, based on the weight of the pyrolysis oil, or based on the weight of all recycle content feedstocks fed to a molecular reforming reaction zone, or based on the weight of all biomass and recycle content feedstocks fed to a molecular reforming reaction zone. In an embodiment or in combination with any of the embodiments mentioned herein, the pyrolysis oil may have a C6 to C12 hydrocarbon content in the range of 10 to 95 weight percent, 20 to 80 weight percent, or 35 to 80 weight percent, or may have a C13 to C23 hydrocarbon content in the range of 1 to 80 weight percent, 5 to 65 weight percent, or 10 to 60 weight percent, or may have a C24+ hydrocarbon content in the range of 1 to 15 weight percent, 3 to 15 weight percent, 2 to 5 weight percent, or 5 to 10 weight percent, or may have a ratio of the C6-C12 hydrocarbon content to the C13-C23 hydrocarbon content of at least 1:1, at least 1.5:1, at least 2:1, at least 2.5:1, at least 3:1, at least 4:1, or at least 5:1 and/or not more than 20:1, not more than 15:1, or not more than 10:1. The pyrolysis oil may also include various amounts of olefins, aromatics, and other compounds. In an embodiment or in combination with any of the embodiments mentioned herein, the pyrolysis oil has an aromatic content that is not higher than 15, or not more than 10, or not more than 8, or not more than 6, in each case weight percent. The pyrolysis oil may have a naphthene content of 1 to 50 weight percent, 5 to 50 weight percent, or 10 to 45 weight percent naphthenes, especially if the r-pyoil was subjected to a hydrotreating process. The pyrolysis oil may have a paraffin content of at least 25, or at least 30, or at least 35, or at least 40, or at least 45, or at least 50, in each case weight percent.

The pyrolysis oil may have a paraffin content of not more than 90, or not more than 85, or not more than 80, or not more than 75, or not more than 70, or not more than 65, or not more than 60, or not more than 55, in each case weight percent. In an embodiment or in combination with any of the embodiments mentioned herein, the pyrolysis oil may have a paraffin content in the range of 25 to 90 weight percent, 35 to 90 weight percent, or 40 to 80, or 40-70, or 40-65 weight percent. The pyrolysis oil may have an n-paraffin content of at least 5, or at least 10, or at least 15, or at least 25, or at least 30, or at least 35, or at least 40, or at least 45, or at least 50, in each case weight percent. The pyrolysis oil may have an n-paraffin content in the range of 25 to 90 weight percent, 35 to 90 weight percent, or 40-70, or 40-65, or 50 to 80 weight percent. The r-pyoil may have a combined paraffin and olefin content of at least 5, or at least 10, or at least 15, or at least 25, or at least 30, or at least 35, or at least 40, or at least 45, or at least 50, in each case weight percent. Additionally, or alternatively, in an embodiment or in combination with any of the embodiments mentioned herein, the r-pyoil may have a combined paraffin and olefin content in the range of 25 to 90 weight percent, 35 to 90 weight percent, or 50 to 80 weight percent. The pyrolysis oil may have a paraffin to olefin weight ratio of at least 0.2:1, or at least 0.3:1, or at least 0.4:1, or at least 0.5:1, or at least 0.6:1, or at least 0.7:1, or at least 0.8:1, or at least 0.9:1, or at least 1:1. Additionally, or alternatively, in an embodiment or in combination with any of the embodiments mentioned herein, the pyrolysis oil may have a paraffin to olefin weight ratio not more than 3:1, or not more than 2.5:1, or not more than 2:1, or not more than 1.5:1, or not more than 1.4:1, or not more than 1.3:1. The pyrolysis oil may have a paraffin to olefin weight ratio in the range of 0.2:1 to 5:1, or 1:1 to 4.5:1, or 1.5:1 to 5:1, or 1.5:1:4.5:1, or 0.2:1 to 4:1, or 0.2:1 to 3:1, 0.5:1 to 3:1, or 1:1 to 3:1. The pyrolysis oil may have an n-paraffin to i-paraffin weight ratio of in the range of 1:1 to 100:1, 4:1 to 100:1, or 15:1 to 100:1.

The pyrolysis oil may have a mid-boiling point of at least 75° C., or at least 80° C., or at least 85° C., or at least 90° C., or at least 95° C., or at least 100° C., or at least 105° C., or at least 110° C., or at least 115° C. The values can be measured according to the procedures described in ASTM D-2887. The pyrolysis oil may have a mid-boiling point of the range of 75 to 250° C., 90 to 225° C., or 115 to 190° C. As used herein, “mid-boiling point” refers to the median boiling point temperature of the pyrolysis oil when 50 weight percent of the pyrolysis oil boils above the mid-boiling point and 50 weight percent boils below the mid-boiling point.

The boiling point range of the pyrolysis oil may be such that not more than 10 percent of the pyrolysis oil has a final boiling point (FBP) of 250° C., 280° C., 290° C., 300° C., or 310° C. To determine the FBP, the procedures described in according to ASTM D-2887 can be employed.

It should be noted that all of the above-referenced hydrocarbon weight percentages may be determined using gas chromatography-mass spectrometry (GC-MS). The pyrolysis oil may exhibit a density at 15° C. in a range of 0.6 to 1 g/cm3, 0.65 to 0.95 g/cm3, or 0.7 to 0.9 g/cm3.

In an embodiment or in combination with any of the embodiments mentioned herein, the pyrolysis oil may exhibit an API gravity at 15° C. of at least 28, or at least 29, or at least 30, or at least 31, or at least 32, or at least 33, or an API gravity at 15° C. at a range of 28 to 50, 29 to 58, or 30 to 44.

Turning to the pyrolysis gas, the pyrolysis gas can have a methane content of at least 1, or at least 2, or at least 5, or at least 10, or at least 11, or at least 12, or at least 13, or at least 14, or at least 15, or at least 16, or at least 17, or at least 18, or at least 19, or at least 20 weight percent, or in the range of 1 to 50 weight percent, 5 to 50 weight percent, or 15 to 45 weight percent. The pyrolysis gas can have a C3 hydrocarbon content of at least 1, or at least 2, or at least 3, or at least 4, or at least 5, or at least 6, or at least 7, or at least 8, or at least 9, or at least 10, or at least 15, or at least 20, or at least 25, in each case weight percent, or in the range of 1 to 50 weight percent, 5 to 50 weight percent, or 20 to 50 weight percent. The pyrolysis gas can have a C4 hydrocarbon content of at least 1, or at least 2, or at least 3, or at least 4, or at least 5, or at least 6, or at least 7, or at least 8, or at least 9, or at least 10, or at least 11, or at least 12, or at least 13, or at least 14, or at least 15, or at least 16, or at least 17, or at least 18, or at least 19, or at least 20, in each case weight percent, or in the range of 1 to 50 weight percent, 5 to 50 weight percent, or 20 to 50 weight percent. The pyrolysis gas can have a combined C3 and C4 hydrocarbon content (including all hydrocarbons having carbon chain lengths of C3 or C4) of at least 5, or at least 10, or at least 15, or at least 20, or at least 25, or at least 30, or at least 35, or at least 40, or at least 45, or at least 50, or at least 55, or at least 60, or at least 65, or at least 70, or at least 75, in each case weight percent, or in the range of 10 to 90 weight percent, 25 to 90 weight percent, or 25 to 80 weight percent.

The mixed plastic waste, or MPW, can include textiles, and natural and/or synthetic fibers, non-woven webs, and plastics. Examples of plastics include polymers such as polyvinylacetate, polyamides including nylon, polyesters such as those polyethylene terephthalate (PET), copolyesters including those made with IPA, CHDM and/or 2,2,4,4-tetramethyl-1,3-cyclobutanediol, polycyclohexylenedimethylene terephthalate (PCT) and other copolymers, olefinic polymers such as polypropylene and polyethylene, polycarbonates, polysulfates, poly sulfones, polyethers such as polyether-urea known as Spandex or elastane, polyacrylates, acrylonitrile copolymers, polyvinylchloride (PVC), polylactic acid, polyglycolic acid, sulfopolyester fibers, SBS (styrene-butadiene-styrene) copolymers, ABS polymers, and combinations thereof. The MPW can be post-consumer and/or post-industrial MPW (also commonly known as pre-consumer).

The MPW can optionally be densified to convert them to the form factor necessary to feed through a feed injector of a POX gasifier. The densified MPW are a collection of densified MPW particles, briquettes, agglomerates, pellets, or rods, or any other shape or size that different from the native shape of the textile from which the densified MPW is made. The densified MPW can be agglomerates, or they can be extrudates or pellets.

The MPW can reduced in size by any means, including by chopping, grinding, shredding, harrowing, confrication, pulverizing, or cutting a feed of MPW to make size reduced MPW. Optionally, the size reduced MPW can continue to be ground, comminuted, pulverized or otherwise size reduced to obtain the desired average particle size if one desires to obtain finer particles. The form of the size reduced MPW will depend on the desired method of densification. For example, the size reduced MPW can be in the form of coarse or fine particles, even a powder (of any shape other than the original shape of the MPW feed). Alternatively, the size reduced MPW can be in the form of a viscous mass that does not have discrete particles. Fluidized bed granulators can be used, optionally with a drying gas, as well as tumbling granulators of disc or drum design connected to high speed mixers having cutting blades on a horizonal or vertical shaft. Examples of different kinds of suitable size reducing processes and equipment as stand-alone or coupled together include air swept mills, knife cutting, fine grinders that can have multiple grinding zones with internal classification systems, choppers with finer knives at the end, disintegrators that can handle shredding of MPW even high moisture feeds and then optional fine cutting or milling into smaller size such as a powder, high speed cutting blades that can have multiple zones for moving coarser material to finer material. The size reducing equipment can also include drying before cutting or simultaneous with drying

Following or simultaneous with the process of size reducing the MPW feed, the size reduced MPW are treated to make a densified MPW in which the individual particles in densified MPW have a bulk density that is higher than the bulk density of the MPW feed used to make the size reduced MPW. The densification process increases the bulk density of the MPW. In one embodiment or in combination with any of the mentioned embodiments, the bulk density of the densified MPW is higher than the bulk density of the MPW fed to the process for size reduction. In one embodiment or in combination with any of the mentioned embodiments, the bulk density of the densified MPW is higher than the bulk density of an isolated size reduced MPW.

In one embodiment, the densification process is accomplished by forming agglomerates without application of external heat source (the “agglomeration process”), or by applying external heat energy in a process for forming particles (“heat treated process”). In one embodiment or in combination with any of the mentioned embodiments, the densified MPW is obtained by an agglomeration process that includes pressure. In one embodiment or in combination with any of the mentioned embodiments, the densified MPW are obtained by an agglomeration process that does not include application of pressure. In one embodiment or in combination with any of the mentioned embodiments, the densified MPW is obtained by a heat-treated process that includes that application of pressure.

Examples of pressure agglomeration include compactors (roll, roll press, double roll press). Compactors roll the material into a sheet, and then feed the material to a flake breaker and granulator. The process is generally a dry process. Another example of pressure agglomeration includes briquetters which produce pillow shape agglomerates in the roll press or double roll press.

Examples of non-pressure agglomeration processes include forming agglomerates with disc pelletizers (also called pan pelletizers or granulators), agglomeration drums, pin mixers, and paddle mixers (pug mills).

Generally, the size of the agglomerates is higher than the size of the size reduced MPW by, for examples, combining or consolidating smaller particles into larger particles to make granules, tablets, briquettes, pellets, or the like. Since agglomerates are consolidated or pressure compacted rather than fused, they can break apart into smaller sizes more easily than extrudates in grinding or milling equipment, such as those used in a coal or petcoke grinder or mill. Agglomerates also produce fewer fines and dust and can easily flow.

The agglomerates, after formed, can be cured, dried, or fired by application of external heat sources.

In one embodiment or in combination with any of the mentioned embodiments, the size reduction process and the densification process in an agglomeration process can be in different zones in the same equipment, or in the same zone in the same equipment, or the size reduced MPW are not discharged and isolated before the application of a densification process. For example, a single equipment can both reduce the size of the MPW feed and densify either in two zones within the body of the agglomerator or even in one zone within the body of the agglomerator.

In one embodiment or in combination with any of the mentioned embodiments, the size reduced MPW are discharged from equipment and isolated prior to feeding the size reduced MPW to a process for densification.

As noted, the densified MPW can be formed by an agglomeration method. This can be accomplished in an agglomerator (also called a densifier) in a batch or continuous mode. The agglomeration method does not include application of external heat energy. In one embodiment or in combination with any of the mentioned embodiments, the agglomeration occurs with the application of frictional heat, or frictional heat only. There are many types of commercial agglomerators available capable of densifying plastics by similar processes. In one embodiment or in combination with any of the mentioned embodiments, the formation of size reduction and densification can occur in the same zone by feeding loose MPW to a chamber of spinning blades that shred the material for a time sufficient to frictionally heat the mass of shredded MPW to a softening point T_{g} of thermoplastic polymer contained in the mass of shredded MPW, or otherwise to at least soften or create a tacky or viscous shredded mass. The softened size reduced viscous mass can optionally be densified and solidified by application of water onto the mass. This process does not isolate the size reduced MPW as particles before densification. The process of size reduction and densification can occur simultaneously. This process can also occur without applied pneumatic or hydraulic pressure during the shredding and densification process. The action of the spinning blades provides the motive force for discharging the densified MPW. Pressure may be applied to discharge the material from the densification zone.

Size reduced MPW are any MPW which have been subjected to a process of cutting, shredding, pulverizing, chopping, or other means to reduce the size of textile from one size to a smaller size.

In another embodiment, the size reduced MPW are fed by a means such as a pneumatic conveyor to a hopper that can be stirred and then fed to an optional discharge auger or screw mounted perpendicular to the hopper or in line and parallel in the vertical plane to the hopper. The rotational speed of the auger or screw is determined by the desired throughput of the agglomeration screw. Optionally, the discharge port, screw, or any location between the hopper and agglomeration screw can be configured to check metal and removed, such as by way of magnets.

The discharge screw or auger feeds the size reduced MPW to an agglomeration zone containing a chamber in which the size reduced MPW are softened, plasticized, sintered, or otherwise compacted. One example of such a chamber is a single or double screw that either is tapered having a diameter that narrows through at least a portion of the shaft length toward the die head or outlet or a variable pitch and/or variable flight straight screw that provides compaction as the textile material moves toward the die head, or any other screw design that provides compaction. The chamber can optionally be vented. The shearing action of the screw and compaction of the textile material as it travels down the screw creates frictional heat to soften the MPW to a temperature effective to create an agglomerate. The screw can be a variable or constant pitch screw or have variable or constant flights. If a die is use, the holes can be configured to any shape and size. A set of rotating knives cut the agglomerated textile material exiting the die to form the densified MPW.

In one embodiment or in combination with any of the mentioned embodiments, the MPW, size reduced MPW, and/or densified MPW can be fed to chamber or process that applies heat energy to the MPW to melt at least a portion of the MPW. Examples include a hot melt granulator or extruder with a die.

In one embodiment or in combination with any of the mentioned embodiments, there is provided a molten blend of size reduced MPW obtained by any conventional melt blending techniques. A molten blend includes MPW completely melted or MPW containing a portion of material that is melted and a portion of material that is not melted. Some material in MPW will not melt before they thermally degrade, such as some natural fibers.

The melt blend can be cooled into sheet or pellet form. For example, the melt blend can be extruded into any form, such pellets, droplets, or other particles, strands, rods, or sheets, which can, if desired, be further granulated and/or pulverized to the desired size.

The type of densified MPW is not limited, and can be any one of those mentioned below, but at least a portion of the MPW contain thermoplastic polymer. Thermoplastic polymers assist to retain the shape and particle integrity, allow their processing, and avoid excessive energy costs. Densified MPW that do not contain any or insufficient thermoplastic polymer content will not retain a consistent discrete shape in downstream size reducing processes, will generate excessive fines, and can have a wide size variation. The amount of thermoplastic polymer, or thermoplastic fibers, in any one of the MPW feed, size reduced MPW, or densified MPW agglomerates is at least 5 wt. %, or at least 10 wt. %, or at least 25 wt. %, or at least 50 wt. %, or at least 75 wt. %, or at least 90 wt. %, or at least 98 wt. %, or 100 wt. %, based on the weight of the corresponding MPW, i.e. MPW feed, size reduced MPW, or densified MPW agglomerates.

In one embodiment or in combination with any of the mentioned embodiments, the densification step includes the application of heat or are processed by a heat-treated process. The size reduced MPW can be subjected to an external source of heat energy at or above the T_{g} of the thermoplastic polymer in the synthetic fibers contained in the size reduced fiber stream, causing the softened or melted thermoplastic MPW to flow around and bind the natural fibers and any thermoset synthetic fibers. Upon cooling, the partially or fully molten MPW are solidified into a desired shape, and optionally further granulated or pulverized to a final desired size in one or more steps), or in the final granulate shape suitable for (i) shipping to a gasification facility for further granulation to a size suitable for introducing into the gasifier or (ii) use as a feed to the gasifier without further granulation iii) shipping to a steam reforming facility for further granulation to a size suitable for introducing into the gasifier or (iv) use as a feed to the steam reforming facility without further granulation.

Turning to the molecular reforming process, an example of a suitable process is a steam reforming process, or a methane steam reforming process. In a steam reforming process, methane is reformed in the presence of steam to make a syngas containing carbon monoxide and hydrogen. A pyrolysis product, such as r-pyoil or r-pygas, can be a suitable feedstock for steam reforming process that is configured to accept a liquid feed. In one embodiment, the fuel feed to the steam reformer can be a liquid light and/or heavy naphtha, fuel gas, fuel oil, atmospheric gas oil (AGO), light and heavy vacuum gas oils (VGO). In one embodiment, r-pyoil is combined with liquid naphtha (or petroleum naphtha) as a feedstock to a steam reformer.

Liquid naphtha is typically derived from petroleum or crude oil refining and typically contains paraffins, aromatics, and naphthalenes, and is often referred to as a heavy naphtha or petroleum naptha. Suitable naphtha streams can have an initial boiling point of 52° C. and a final boiling point of 205° C., and a heavy naphtha will typically have an initial boiling point of about 140° C. and final boiling point of about 205° C. A heavy naphtha can compounds principally in the C6+ range, can have more than 50% paraffins in the C6-C9 range, and up to 40% naphthalenes and aromatics. Other suitable sources of liquid naphtha include cracked naphtha streams.

A stream of liquid naphtha (desirably heavy naphtha) is combined with a stream of r-pyoil and vaporized in a pre-heater or in a pre-reformer to form a combined vaporized naphtha-stream. Vaporization can occur at a temperature ranging from the boiling point of naphtha up to about 550° C., or not more than 430° C., or not more than 410° C., or not more than 400° C. The temperature should adjusted to avoid substantially cracking the naphtha and r-pyoil. If necessary, the liquid naphtha and/or the r-pyoil can be subjected to a desulfurization process to remove residual sulfur prior to vaporization.

To the stream of vaporized heavy naphtha-r-pyoil can be added steam, typically superheated to a temperature of above 1500 F. Suitable steam:carbon ratios can range from 1:1 to 6:1, or 2:1 to 3:1. The combined vaporized naphta-r-pyoil and steam can be fed into a pre-reformer (also called a gas conditioning vessel) or each of the r-pyoil, liquid naphtha, and steam can be separately or in sub-combinations be fed into the pre-reformer. The r-pyoil and liquid naptha can be pre-heated and vaporized before entering the pre-reformer, or can be introduced into the pre-reformer as liquids and vaporized in the pre-reformer. The vaporized naphtha-r-pyoil and steam can pass through tubes packed with a catalyst and heated to a temperature suitable to make a reformer feedstock containing methane. The gas conditioning vessel or pre-reformer alleviates carbon deposition in the reformer that higher hydrocarbons have a tendency toward at higher temperatures. The pre-reformer can be operated at a gas temperature ranging from 780° C. to 930° C., or it can be catalytic and operate at gas temperatures of 400° C. to 550° C., or from 410° C. to 510° C., where the feedstock to the pre-reformer is converted to a gas stream containing methane and carbon oxides (e.g. dioxide) suitable as a feedstock to the reformer. Typical pre-reformed catalysts can be nickel supported on aluminum and magnesium.

The pre-reformer effluent is fed to a primary steam reformer, desirably a catalytic steam reformer. Examples of other suitable reformers include fluidized bed membrane reactors which can simplify the purification process by obtaining a raw effluent of high hydrogen purity and catformers.

The primary reformer converts methane in the pre-reformer effluent to hydrogen and carbon dioxide. The primary reformer and catalyst can be of any conventional design and composition, typically containing vertically arranged tubes containing the heterogeneous catalyst. The tubes are heated by combustion of a fuel such as natural gas in the presence of oxygen to a temperature of at least 700° C., or more than 720° C., or more than 780° C. or more than 800° C. and generally up to about 900° C. Suitable pressures range from 1.5 to 3 MPa. The catalyst can be any suitable reformer catalyst, such as a finely divided nickel on calcium oxide/aluminum oxide, α-Al₂O₃, aluminosilicates, or magnesia supports. An additional amount of steam can be added to the pre-reformed effluent fed to the primary reformer. Desirably, at least 50%, or at least 60%, or at least 65% or at least 70% of the methane is converted to hydrogen and carbon monoxide to form a hydrogen enriched syngas stream.

The syngas stream can then optionally be fed to a secondary reformer, where syngas is combined with preheated compressed air. The oxygen in the compressed air reacts with some of the hydrogen to make steam, which in turn reacts with any residual methane in the syngas stream to make more hydrogen and carbon monoxide. The secondary reformer can also be a catalytic reformer containing nickel catalyst. The compressed air also serves as a source of nitrogen in an amount sufficient to generate the desired hydrogen to nitrogen molar ratio for ammonia synthesis. This can be a 1:1 to 4:1 molar ratio or a suitable molar ratio to provide the required amount of nitrogen needed in ammonia synthesis. For example, the molar ratio can be higher than 3:1 if an additional source of nitrogen is used in ammonia synthesis, or lower than 3:1 if additional hydrogen is made in, for example, a water gas shift reaction. The secondary reformer generates a nitrogen containing hydrogen enriched syngas that can be cooled below 400° C. to make is useful in ammonia synthesis. The nitrogen containing hydrogen enriched syngas contains hydrogen, nitrogen, carbon monoxide, and carbon dioxide and typically less than 1%, or not more than 0.5%, or not more than 0.25% methane by volume.

The hydrogen enriched syngas effluent (this term including the hydrogen enriched syngas effluent from the primary reformer and/or the nitrogen containing hydrogen enriched syngas stream from the secondary reformer) from the steam reformer (which can include a primary or a primary and secondary reformer) can be further enriched in hydrogen to make a hydrogen enriched stream depleted in carbon monoxide. The hydrogen enriched syngas effluent can be subjected to a shift reaction to convert carbon monoxide in the presence of water to carbon dioxide while generating more hydrogen and thereby form a hydrogen enriched stream depleted of carbon monoxide. Any conventional gas water shift design is suitable. The water gas shift reaction can take place in a high temperature reactor and a lower temperature shift reactor. The high temperature shift reaction can take place in the presence of a catalyst at high temperature, such as chromium oxide initiator and iron oxide catalyst. The low temperature shift reaction can take place at a lower temperature in the presence of a catalyst such a Cu—Zn or Cu—Zn—Al.

The hydrogen enriched stream depleted of carbon monoxide can be purified by scrubbing or pressure swing absorption to remove carbon dioxide, and methanation to remove residual carbon oxides if needed.

In the purification process, carbon dioxide is removed. Due to the conversion of carbon monoxide to carbon dioxide in the shift reaction along with residual carbon dioxide present in the enriched syngas stream, the hydrogen enriched stream depleted of carbon monoxide can be scrubbed to remove carbon dioxide using a conventional absorber/stripper combination, or can be fed to a pressure swing absorption unit, to thereby form a purified hydrogen stream depleted of carbon dioxide. Suitable scrubbers to remove carbon dioxide include amine scrubbers and caustic scrubbers. In an amine scrubber, monoethanolamine (MEA) can be used to aid in the removal of carbon dioxide. In caustic scrubbing, sodium or potassium hydroxide can be used to aid the removal of carbon dioxide.

Final traces of carbon dioxide and carbon monoxide, if present, can be removed in a catalytic methanation process by passing the purified hydrogen stream depleted of carbon dioxide over nickel catalyst at temperatures of 400 to 600° C. and high pressures of 1-3 KPa.

In a process that includes a secondary reformer, the purified hydrogen stream (optionally methanated) can contain a hydrogen to nitrogen molar ratio of about 2.8:1 to 3.2:1, or desirably about 3:1, or from 70% to 80% hydrogen, 20% to 30% nitrogen, and less than 2%, or not more than 1.5%, or not more than 1.25% of a combination of methane, carbon dioxide, and carbon monoxide, or optionally not more than 0.25%, or not more than 0.1% of a combination of carbon oxides, each by moles. In a process that employs only a primary steam reformer, the purified hydrogen stream can contain at least 95%, or at least 97%, or at least 98%, or at least 99% hydrogen, and less than 2% or not more than 1.25% methane and carbon oxides, and optionally not more than 0.5%, or not more than 0.25%, or not more than 0.1% carbon oxides.

The purified hydrogen stream is reacted with nitrogen in any conventional ammonia synthetic process, such as the Haber-Bosch process, to make ammonia. 3 moles of H2 react with a mole of N2 to make ammonia.

In the ammonia synthesis step, the purified hydrogen stream containing nitrogen can be compressed at pressures ranging from 50 to 400 atm, or from 135 atm to 350 atm. The source of nitrogen can be present in the purified nitrogen stream, or that is added as a fresh feed of nitrogen obtained from any other process, such as an air separation unit, or both as needed. The compressed purified hydrogen stream is introduced into a conversion zone where it is passed across a fixed bed catalyst. In the conversion zone, the reaction of hydrogen and nitrogen occurs under high pressure and moderate temperatures in the presence of a fixed bed catalyst such as iron oxide Fe₃O₄ which is reduced to iron by hydrogen, or ruthenium supported on graphite. Aluminum oxide and potassium oxide can be added as promoters. Suitable reaction pressures range from 50 to 1000 atmospheres and reaction temperatures range from 180° C. to 370° C., although to maximize yield and balance energy requirements, reaction pressures from 50 to 400 atm, or from 50 to 200 atm at temperatures from 180° C. to 250° C. are desirable. The resulting ammonia is cooled generally down to 0° C. and is separated from the unconverted gases in a liquid-vapor separator. The unconverted gases can be further recycled and processed by compressing them and preheating them before entering the conversion zone.

As an alternative or in addition to steam reforming as a source of purified hydrogen, a partial oxidation molecular reforming process may be employed. In the partial oxidation process, a carbon containing feedstock is introduced into a partial oxidation gasifier in which the feedstock is converted under high pressure and high temperature in sub-stoichiometric amounts of oxygen to syngas containing carbon monoxide and hydrogen. As used herein, the term “partial oxidation” to high temperature conversion of a carbon-containing feed into syngas (carbon monoxide, hydrogen, and carbon dioxide), where the conversion is carried out in the presence of a sub-stoichiometric amount of oxygen. The conversion can be of a hydrocarbon-containing feed and can be carried out with an amount of oxygen that is less than the stoichiometric amount of oxygen needed for complete oxidation of the feed—i.e., all carbon oxidized to carbon dioxide and all hydrogen oxidized to water. The feed to POX gasification can include solids, liquids, and/or gases.

The POX gasifier can be fed with the MPW or r-pyrolysis products or both, optionally with a fossil fuel, along with an oxidizer gas into a gasification reaction zone or chamber of a synthesis gas generator (gasifier) and gasified in the presence of the oxidizer. A hot gas stream is produced in the gasification zone, optionally refractory lined, at high temperature and high pressure generating a molten slag, soot, ash and gases including hydrogen, carbon monoxide, carbon dioxide and can include other gases such as methane, hydrogen sulfide and nitrogen depending on the fuel source and reaction conditions. The hot gas stream is produced in the reaction zone is cooled using a syngas cooler or in a quench water bath at the base of the gasifier which also solidifies ash and slag and separates solids from the gases. The quench water bath also acts as a seal to maintain the internal temperature and pressure in the gasifier while the slag, soot and ash are removed into a lock hopper. The cooled product gas stream removed from the gasifier (the raw densified MPW derived syngas stream) can be further treated with water to remove remaining solids such as soot, and then further treated to remove acid gas (e.g. hydrogen sulfide) after optionally further cooling and shifting the ratio of carbon monoxide to hydrogen.

The feedstock to the POX gasifier can be MPW or a pyrolysis product, optionally in combination with a fossil fuel, such as natural gas (methane) or solid fossil fuel (PET coke or coal). A solid fossil fuel can be coal, petcoke, or any other solid at 25° C. and 1 atmosphere that is a byproduct from refining oil or petroleum. The fossil fuel portion of the feedstock composition is to be distinguished from MPW or r-pyrolysis products even though they are carbonaceous and in part derived from raw materials obtained from refining crude oil. A fossil fuel can include liquid fossil fuels, such as liquid hydrocarbons or streams obtained from refining crude oil, or waste streams from chemical synthetic processes, or gaseous such as natural gas, or solid such as coal or PET coke.

The method generally comprises feeding the MPW or pyrolysis product and an oxidizing agent comprising molecular oxygen (02) into a POX gasifier and performing a partial oxidation reaction within the gasifier by reacting at least a portion of the MPW and/or pyrolysis product. The MPW may be in solid form, or converted to liquid form prior to being fed to the POX gasifier. In one or more embodiments, the MPW can be combined with a solid fossil fuel and the combined feedstock fed to the POX gasifier as a slurry. Alternatively, the MPW can be fed to the POX gasifier as a molten stream. Likewise, a solid pyrolysis product such as a pyrolysis char can be combined with a solid fossil fuel and together fed as a slurry to a POX gasifier. Similarly, a liquid pyrolysis product can be fed to the POX gasifier as a liquid stream, particularly when the POX gasifier is fueled by methane. The combining, when present, may take place in a continuous or batch manner. The feed stream can be in the form of a gas, a liquid or liquified plastic, solids (usually comminuted), or a slurry. The POX gasifier can optionally also be fed with methane or a solid fossil fuel.

The feed stream(s) can be in the form of a gas, a liquid or liquified plastic, solids (usually comminuted), and/or a slurry, and will generally include at least one plastic material or plastic material-containing feedstock. In an embodiment or in combination with any embodiment mentioned herein, the gasification feedstock stream may also comprise at least 1, at least 5, at least 10, at least 15, at least 20, at least 25, at least 30, at least 35, at least 40, at least 45, or at least 50 weight percent of one or more optional fossil fuels, based on the total weight of the gasification feedstock stream. Additionally, or in the alternative, the gasification feedstock stream may also comprise not more than 99, not more than 90, not more than 80, not more than 70, not more than 60, not more than 50, not more than 40, not more than 30, not more than 20, not more than 10, not more than 5, not more than 4, not more than 3, not more than 2, or not more than 1 weight percent of one or more optional fossil fuels, based on the total weight of the gasification feedstock stream. In one or more embodiments, the gasification feed stock stream may comprise from 1 to 99, from 5 to 90, from 10 to 80, from 15 to 70, from 20 to 60, from 30 to 50, or from 35 to 40 weight percent of one or more optional fossil fuels. Such fossil fuels may, for example, comprise solid fuels. Such fossil fuels may, for example, comprise organic materials that are short chain, such as those with a carbon number of less than 12, and are typically oxygenated. Exemplary fossil fuels include, but are not limited to, solid fuels (e.g., coal, pet coke, waste plastics, etc.) such as coal, liquid fuels (e.g., liquid hydrocarbons, liquefied plastics, etc.), gas fuels (e.g., natural gas, organic hydrocarbons, etc.) and/or other traditional fuel(s) having a positive heating value including products derived from a chemical synthesis process utilizing a traditional fossil fuel as a feedstock. Other possible fossil fuels may include, but are not limited to, fuel oil and liquid organic waste streams. The fossil fuels may include or contain one or more vitrification materials. As used herein, a “gasification feedstock” or “gasifier feed” refers to all components fed into the gasifier except oxygen. In one or more embodiments, the MPW or pyrolysis product is introduced to the gasifier without being combined with coal and/or without any coal being fed separately to the gasifier.

The plastic material feedstock can be fed into a commercial gasifier, thus at a flow rate of greater than 453 kg/hr (1000 lbs/hr), greater than 2,268 kg/hr (5000 lbs/hr), greater than 4,530 kg/hr (10,000 lbs/hr), greater than 9,072 kg/hr (20,000 lbs/hr), greater than 18,144 kg/hr (40,000 lbs/hr), greater than 36,287 kg/hr (80,000 lbs/hr), or greater than 54,431 kg/hr (120,000 lbs/hr) and not more than not more than 226, 800 kg/hr (500,000 lbs/hr), not more than 181,437 kg/hr (400,000 lbs/hr), not more than 136,078 kg/hr (300,000 lbs/hr), not more than 90,720 kg/hr (200,000 lbs/hr), or not more than 68,039 kg/hr (150,000 lbs/hr). In one or more embodiments, the plastic material feedstock comprises at least 20, at least 30, at least 40, at least 50, at least 60, at least 70, at least 80, or at least 90 weight percent of the streams being fed to the POX gasifier.

The POX gasification unit may comprise a gas-fed, a liquid-fed, or a solid-fed gasifier. In an embodiment or in combination with any embodiment mentioned herein, the POX gasification facility may perform liquid-fed POX gasification. As used herein, “liquid-fed POX gasification” refers to a POX gasification process where the feed to the process comprises predominately (by weight) components that are liquid at 25° C. and 1 atm. Additionally, or alternatively, POX gasification unit may perform gas-fed POX gasification. As used herein, “gas-fed POX gasification” refers to a POX gasification process where the feed to the process comprises predominately (by weight) components that are gaseous at 25° C. and 1 atm. Additionally, or alternatively, POX gasification unit may conduct solid-fed POX gasification. As used herein, “solid-fed POX gasification” refers to a POX gasification process where the feed to the process comprises predominately (by weight) components that are solid at 25° C. and 1 atm.

Gas-fed, liquid-fed, and solid-fed POX gasification processes can be co-fed with lesser amounts of other components having a different phase at 25° C. and 1 atm. Thus, gas-fed POX gasifiers can be co-fed with liquids and/or solids, but only in amounts that are less (by weight) than the amount of gasses fed to the gas-phase POX gasifier; liquid-fed POX gasifiers can be co-fed with gasses and/or solids, but only in amounts (by weight) less than the amount of liquids fed to the liquid-fed POX gasifier; and solid-fed POX gasifiers can be co-fed with gasses and/or liquids, but only in amounts (by weight) less than the amount of solids fed to the solid-fed POX gasifier. In an embodiment or in combination with any embodiment mentioned herein, the total feed to a gas-fed POX gasifier can comprise at least 60, at least 70, at least 80, at least 90, or at least 95 weight percent of components that are gaseous at 25° C. and 1 atm; the total feed to a liquid-fed POX gasifier can comprise at least 60, at least 70, at least 80, at least 90, or at least 95 weight percent of components that are liquid at 25° C. and 1 atm; and the total feed to a solid-fed POX gasifier can comprise at least 60, at least 70, at least 80, at least 90, or at least 95 weight percent of components that are solids at 25° C. and 1 atm.

The gasification feeds streams may be introduced into a gasification reactor along with an oxidizing agent stream into a pressurized gasification zone having, for example, a pressure, typically at least 500, at least 600, at least 800, or at least 1,000 psig, (or at least 35, at least 40, at least 55, or at least 70 barg). Generally, to enhance the production of hydrogen and carbon monoxide, the oxidation process involves partial, rather than complete, oxidization of the gasification feedstock and, therefore, may be operated in an oxygen-lean environment, relative to the amount needed to completely oxidize 100 percent of the carbon and hydrogen bonds. In an embodiment or in combination with any embodiment mentioned herein, the total oxygen requirements for the gasifier may be at least 5, at least 10, at least 15, or at least 20 percent in excess of the amount theoretically required to convert the carbon content of the gasification feedstock to carbon monoxide. In general, satisfactory operation may be obtained with a total oxygen supply of 10 to 80 percent in excess of the theoretical requirements. For example, examples of suitable amounts of oxygen per pound of carbon may be in the range of 0.4 to 3.0, 0.6 to 2.5, 0.9 to 2.5, or 1.2 to 2.5 pounds free oxygen per pound of carbon.

In one or more embodiments, the POX gasifier is an entrained flow gasifier that generates a raw syngas stream, under slagging or non-slagging conditions.

In an embodiment or in combination with any embodiment mentioned herein, the type of gasification technology employed may be a partial oxidation entrained flow gasifier that generates syngas. This technology is distinct from fixed bed (alternatively called moving bed) gasifiers and from fluidized bed gasifiers. An exemplary gasifier that may be used in depicted in U.S. Pat. No. 3,544,291, the entire disclosure of which is incorporated herein by reference to the extent not inconsistent with the present disclosure. However, in an embodiment or in combination with any embodiment mentioned herein, other types of gasification reactors may also be used within the scope of the present technology.

In an embodiment or in combination with any embodiment mentioned herein, the gasifier/gasification reactor can be non-catalytic, meaning that the gasifier/gasification reactor does not contain a catalyst bed and the gasification process is non-catalytic, meaning that a catalyst is not introduced into the gasification zone as a discrete unbound catalyst. The gasification process may be a slagging gasification process; that is, operated under slagging conditions (well above the fusion temperature of ash) such that a molten slag 194 (FIG. 6) is formed in the gasification zone and runs along and down the refractory walls.

In an embodiment or in combination with any embodiment mentioned herein, the gasification zone, and optionally all reaction zones in the gasifier/gasification reactor, may be operated at a temperature of at least 1000° C., at least 1100° C., at least 1200° C., at least 1250° C., or at least 1300° C. and/or not more than 2500° C., not more than 2000° C., not more than 1800° C., or not more than 1600° C. The reaction temperature may be autogenous. Advantageously, the gasifier operating in steady state mode may be at an autogenous temperature and does not require application of external energy sources to heat the gasification zone.

In an embodiment or in combination with any embodiment mentioned herein, the gasifier is a predominately gas fed gasifier. The gasifier can also be either a non-slagging gasifier or operated under conditions not to form a slag, or alternatively, may be a slagging gasifier.

In an embodiment or in combination with any embodiment mentioned herein, the gasifier may be operated at a pressure within the gasification zone (or combustion chamber) of at least 200 psig (1.38 MPa), 300 psig (2.06 MPa), 350 psig (2.41 MPa), 400 psig (2.76 MPa), 420 psig (2.89 MPa), 450 psig (3.10 MPa), 475 psig (3.27 MPa), 500 psig (3.44 MPa), 550 psig (3.79 MPa), 600 psig (4.13 MPa), 650 psig (4.48 MPa), 700 psig (4.82 MPa), 750 psig (5.17 MPa), 800 psig (5.51 MPa), 900 psig (6.2 MPa), 1000 psig (6.89 MPa), 1100 psig (7.58 MPa), or 1200 psig (8.2 MPa). Additionally or alternatively, the gasifier may be operated at a pressure within the gasification zone (or combustion chamber) of not more than 1300 psig (8.96 MPa), 1250 psig (8.61 MPa), 1200 psig (8.27 MPa), 1150 psig (7.92 MPa), 1100 psig (7.58 MPa), 1050 psig (7.23 MPa), 1000 psig (6.89 MPa), 900 psig (6.2 MPa), 800 psig (5.51 MPa), or 750 psig (5.17 MPa). Examples of suitable pressure ranges include 300 to 1000 psig (2.06 to 6.89 MPa), 300 to 750 psig (2.06 to 5.17 MPa), 350 to 1000 psig (2.41 to 6.89 MPa), 350 to 750 psig (2.06 to 5.17 MPa), 400 to 1000 psig (2.67 to 6.89 MPa), 420 to 900 psig (2.89 to 6.2 MPa), 450 to 900 psig (3.10 to 6.2 MPa), 475 to 900 psig (3.27 to 6.2 MPa), 500 to 900 psig (3.44 to 6.2 MPa), 550 to 900 psig (3.79 to 6.2 MPa), 600 to 900 psig (4.13 to 6.2 MPa), 650 to 900 psig (4.48 to 6.2 MPa), 400 to 800 psig (2.67 to 5.51 MPa), 420 to 800 psig (2.89 to 5.51 MPa), 450 to 800 psig (3.10 to 5.51 MPa), 475 to 800 psig (3.27 to 5.51 MPa), 500 to 800 psig (3.44 to 5.51 MPa), 550 to 800 psig (3.79 to 5.51 MPa), 600 to 800 psig (4.13 to 5.51 MPa), 650 to 800 psig (4.48 to 5.51 MPa), 400 to 750 psig (2.67 to 5.17 MPa), 420 to 750 psig (2.89 to 5.17 MPa), 450 to 750 psig (3.10 to 5.17 MPa), 475 to 750 psig (3.27 to 5.17 MPa), 500 to 750 psig (3.44 to 5.17 MPa), or 550 to 750 psig (3.79 to 5.17 MPa).

The temperature within the gasification zone, and optionally all reaction zones within the POX gasifier can be at least 1000° C. (1100° C., 1200° C., 1250° C., or 1300° C.) and/or not more than 2500° C. (2000° C., 1800° C., or 1600° C.).

Generally, the average residence time of gases in the gasifier reactor can be very short to increase throughput. Since the gasifier may be operated at high temperature and pressure, substantially complete conversion of the feedstock to gases can occur in a very short time frame. In an embodiment or in combination with any embodiment mentioned herein, the average residence time of the gases in the gasifier can be not more than 30, not more than 25, not more than 20, not more than 15, not more than 10, or not more than 7 seconds.

To avoid fouling downstream equipment from the gasifier, and the piping in-between, the resulting raw syngas stream may have a low or no tar content. In an embodiment or in combination with any embodiment mentioned herein, the syngas stream discharged from the gasifier may comprise not more than 4, not more than 3, not more than 2, not more than 1, not more than 0.5, not more than 0.2, not more than 0.1, or not more than 0.01 weight percent of tar based on the weight of all condensable solids in the syngas stream. For purposes of measurement, condensable solids are those compounds and elements that condense at a temperature of 15° C. and 1 atm. Examples of tar products include naphthalenes, cresols, xylenols, anthracenes, phenanthrenes, phenols, benzene, toluene, pyridine, catechols, biphenyls, benzofurans, benzaldehydes, acenaphthylenes, fluorenes, naphthofurans, benzanthracenes, pyrenes, acephenanthrylenes, benzopyrenes, and other high molecular weight aromatic polynuclear compounds. The tar content can be determined by GC-MSD.

Generally, the raw syngas stream discharged from the gasification vessel includes such gases as hydrogen, carbon monoxide, and carbon dioxide and can include other gases such as methane, hydrogen sulfide, and nitrogen depending on the fuel source and reaction conditions. As used herein, the term “raw syngas” refers to a synthesis gas composition comprising carbon monoxide (CO) and hydrogen (H2) discharged from a partial oxidation (POX) gasifier and before any further treatment, for example, by way of scrubbing, shift, or acid gas removal. In an embodiment or in combination with any embodiment mentioned herein, the raw syngas is discharged from the POX gasifier at a temperature of 200 to 1500 (or 220 to 400) ° C. and/or a pressure of 101 kPa to 8.27 MPa (6.21 to 7.58 MPa) (14.7 to 1200 (or 900 to 1100) psig).

Generally, the raw syngas stream discharged from the gasification vessel includes such gases as hydrogen, carbon monoxide, and carbon dioxide and can include other gases such as methane, hydrogen sulfide, and nitrogen depending on the fuel source and reaction conditions.

In an embodiment or in combination with any embodiment mentioned herein, the raw syngas stream (the stream discharged from the gasifier and before any further treatment by way of scrubbing, shift, or acid gas removal) can have the following composition in mole percent on a dry basis and based on the moles of all gases (elements or compounds in gaseous state at 25° C. and 1 atm) in the raw syngas stream:
a hydrogen content in the range of 32 to 50 percent, or at least 33, at least 34, or at least 35 and/or not more than 50, not more than 45, not more than 41, not more than 40, or not more than 39 percent, or it can be in the range of 33 to 50 percent, 34 to 45 percent, or 35 to 41 percent, on a dry volume basis; and/or
a carbon monoxide content of at least 35, at least 40, at least 41, at least 42, or at least 43 and/or not more than 55, not more than 54, not more than 53, or not more than 52 weight percent, based on the total weight of the stream, or in the range of from 35 to 55 weight percent, 40 to 55 weight percent, 41 to 54 weight percent, or 42 to 53 weight percent, based on the total weight of the stream on a dry basis; and/or
a carbon dioxide content of at least 1%, at least 1.5%, at least 2%, at least 3%, at least 4%, at least 5%, at least 6%, or at least 7% by volume and/or not more than 25%, not more than 20%, not more than 18%, not more than 15%, not more than 12%, not more than 11%, not more than 10%, not more than 9%, not more than 8%, or not more than 7% by volume on a dry basis; and/or
a methane content of not more than 5000, not more than 2500, not more than 2000, or not more than 1000 ppm by volume methane on a dry basis; and/or
a sulfur content of not more than 1000, not more than 500, nor more than 100, not more than 50, or nor more than 10, or nor more than 5, or not more than 1 ppm by weight (ppmw); and/or
a soot content of at least 1000, or at least 5000 ppm and/or not more than 50,000, not more than 20,000, or not more than 15,000 ppmw; and/or
a halides content of not more than 1000, not more than 500, not more than 200, not more than 100, or not more than 50 ppmw;
and/or
a mercury content of not more than 0.01, not more than 0.005, or not more than 0.001 ppmw; and/or
an arsine content of not more than 0.1 ppm, not more than 0.05, or not more than 0.01 ppmw; and/or
a nitrogen content of not more than 10,000, not more than 3000, not more than 1000, or not more than 100 ppmw nitrogen; and/or
an antimony content of at least 10 ppmw, at least 20 ppmw, at least 30 ppmw, at least 40 ppmw, or at least 50 ppmw, and/or not more than 200 ppmw, not more than 180 ppmw, not more than 160 ppmw, not more than 150 ppmw, or not more than 130 ppmw; and/or
a titanium content of at least 10 ppmw, at least 25 ppmw, at least 50 ppmw, at least 100 ppmw, at least 250 ppmw, at least 500 ppmw, or at least 1000 ppmw, and/or not more than 40,000 ppmw, not more than 30,000 ppmw, not more than 20,000 ppmw, not more than 15,000 ppmw, not more than 10,000 ppmw, not more than 7,500 ppmw, or not more than 5,000 ppmw; and/or
an inorganic matter (e.g. ash) content of not more than 3000, not more than 2000, or not more than 1000 ppmw; and/or
not more than 4, not more than 3, not more than 2, or not more than 1 weight percent unconverted carbon on a dry basis.

As used herein, the term “unconverted carbon” refers to carbon-containing compounds from the gasifier feed(s) that are not converted to carbon monoxide or carbon dioxide.

In an embodiment or in combination with any embodiment mentioned herein, the syngas comprises a molar hydrogen/carbon monoxide ratio of 0.7 to 2, 0.7 to 1.5, 0.8 to 1.2, 0.85 to 1.1, or 0.9 to 1.05.

In an embodiment or in combination with any embodiment mentioned herein, the raw syngas composition comprises sulfur, soot, and either carbon dioxide or methane in any amount specified herein. For example, the raw syngas composition can contain sulfur in an amount of not more than 500 ppmw, soot in an amount of at least 1000 ppmw and not more than 20,000 ppmw, and either carbon dioxide in an amount of at least 5% and not more than 15% by volume or methane in an amount of not more than 2000 ppm by volume.

In an embodiment or in combination with any embodiment mentioned herein, the raw syngas composition comprises methane and either sulfur or soot in any amount specified herein. For example, the raw syngas composition can contain methane in an amount of not more than 2000 ppm by volume and either sulfur in an amount of not more than 500 ppmw or soot in an amount of at least 1000 ppmw and not more than 20,000 ppmw. The raw syngas composition can contain a molar ratio of hydrogen to carbon monoxide of 1.0 to 1.4, and/or halides in an amount of no more than 100 ppmw, and/or mercury in an amount of no more than 0.001 ppmw, and/or arsine in an amount of no more than 0.5 ppmw; and/or can contain methane in an amount of not more than 2000 ppm by volume, and/or antimony in an amount of at least 20 ppmw but not more than 150 ppmw, and/or titanium in an amount of at least 20 ppmw but not more than 10,000 ppmw, and/or can contain soot in an amount of at least 1000 ppmw and not more than 20,000 ppmw, and/or can contain a molar ratio of hydrogen to carbon monoxide of 1.0 to 1.4; and/or can contain not more than 5, not more than 4, not more than 3, not more than 2, or not more than 1 weight percent of arsine (AsH₃), nitrogen, mercury, and inorganic matter (ash), collectively.

The gas components can be determined by Flame Ionization Detector Gas Chromatography (FID-GC) and Thermal Conductivity Detector Gas Chromatography (TCD-GC) or any other method recognized for analyzing the components of a gas stream.

In an embodiment or in combination with any embodiment mentioned herein, the recycle content syngas (whether by steam reforming or POX gasification) can have a recycle content of at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent, based on the total weight of the syngas stream.

Weight percentages expressed on the MPW are the weight of the MPW as fed to the first stage separation and prior to addition of any diluents/solutions such as salt or caustic solutions.

MPW and/or a pyrolysis product can be used as a feedstock component to the POX gasifier. For example, a method to make syngas includes (a) feeding MPW and/or a pyrolysis product and molecular oxygen (02) into a POX gasifier; and (b) performing a partial oxidation reaction within the gasifier by reacting at least a portion of the MPW and/or pyrolysis product and the molecular oxygen to form the synthesis gas. The feedstock stream introduced into the POX gasifier can include:
a. A solid fossil fuel such as coal or PET coke with MPW solids;
b. A solid fossil fuel such as coal or PET coke with MPW solids with water to form a slurry introduced into the gasifier;
c. MPW solids with no solid fossil fuel (e.g. coal, PET coke)
d. MPW solids with no fossil fuel (e.g. natural gas, coal, PET coke):
e. A solid fossil fuel such as coal or PET coke with r-pyrolysis products, such r-pyrolysis products including either char or liquids such as r-pyoil;
f. A solid fossil fuel, such as coal or PET coke, with r-pyrolysis products and water to form a slurry introduced into the gasifier, such r-pyrolysis products including either char or liquids such as r-pyoil;
g. r-pyrolysis products with no solid fossil fuel, such r-pyrolysis products including char, r-pyoil, or pyrolysis gas;
h. A gaseous fossil fuel such as natural gas (methane or other alkane) with r-pyrolysis products, such r-pyrolysis products being r-pyoil or pyrolysis gas or both;
i. A liquid fossil fuel (e.g. oils) with liquid r-pyrolysis products.

The MPW can be fed as a solid, or it can be liquified. Liquification processes include dissolving the plastic in a solvent, or melting the plastic to a molten stream, or depolymerizing the plastic sufficiently to convert it to a liquid at 25° C. If desired, the MPW or pyrolysis product can be combined with the fossil fuel prior to being introduced into the gasification zone in the gasifier or prior to being introduced into the feed injector, or they can be combined. For example, there is provided a gaseous fossil fuel feed and a liquid pyrolysis feed separately introduced into the gasification zone or separately introduced into a feed injector of a POX reactor. Alternatively, a solid fossil fuel fed to a POX gasifier and can combined with MPW or a pyrolysis product and as a combined stream fed to a POX gasification zone or introduced to a feed injector.

Combined streams of fossil fuels and MPW and/or r-pyrolysis products, the combined stream can be a two phase or three phase system. The solids concentration in a two phase stream such as a slurry can be from 50 to 85 wt. %, or from 60 to 75 wt. %.

The flow rate of MPW or r-pyrolysis products to a stream reformed or POX gasifier can be suitable for a commercial scale production of syngas; that is a feed rate of greater than 453, 2,268, 4,530, 9,072, 18,144, 36,287, or 54,431 kg/hr (or 1000, 5000, 10,000, 20,000, 40,000, 80,000, or 120,000 lbs/hr).

The syngas generated from a POX gasifier can optionally be purified through a soot removal process, an acid gas (CO2 and H2S) removal process, and can also optionally be fed into a shift reactor as described above to generate the desired amount of hydrogen. Optionally, the carbon monoxide present in the syngas stream can be separated by cooling in a cold box for use in other reactive processes, such as carbonylation processes. Whether subjecting the syngas stream to water gas shift or separation processes, the resulting purified hydrogen stream can be fed to an ammonia synthesis plant.

If the purified hydrogen stream is derived from a POX gasifier syngas, a separate source of nitrogen must be added in the ammonia synthesis, such from an air separation unit. AS noted above, the nitrogen and hydrogen stream are compressed and introduced into a conversion zone where they are passed across a fixed bed catalyst in the same manner as noted above.

The resulting ammonia can have a recycle content that is a physical recycle content (direct) or have a recycle content credit applied to ammonia (indirect).

A direct recycle content ammonia can be made by fluid (e.g. gaseous) communication between the production of syngas and ammonia, such that at least a portion of the hydrogen molecules in the syngas stream flow to the ammonia synthesis reaction zone.

There is also provided a circular manufacturing process comprising:
a. receiving MPW and/or a pyrolysis product obtained from MPW,
b. depositing a recycle content credit from said MPW and/or pyrolysis product into a recycle content inventory,
c. making syngas through a steam reforming process or through a partial oxidation gasifier,
d. reacting hydrogen in said syngas with nitrogen to make ammonia; and
e. applying a recycle content credit to said ammonia obtained from the recycle content inventory.

In this or in combination with any of the mentioned embodiments, a recycle content credit can be applied to a syngas stream, purified hydrogen stream, or to ammonia.

The person or entity generating, depositing, applying or otherwise supplying the credit can be controlled by the same entity or person(s) or a variety of affiliates that are ultimately controlled or owned at least in part by a parent entity (“Family of Entities”), or they can be from a different Family of Entities. Generally, a recycle content credit is associated and travels with a composition and with the downstream derivates of the composition. An allocation of recycle content may be deposited into a recycle inventory and withdrawn from the recycle inventory as a credit (also known as an allocation) and applied to a composition to make a recycle content composition.

A “recycle content credit” and “credit” is representative of a quantity of MPW or pyrolysis product that is or will be processed. For example:
a. the manufacturer of syngas or a purified hydrogen stream can apply the recycle content credit to the syngas stream or a purified hydrogen stream that is sold, or can apply the recycle content credit to ammonia, or
b. the ammonia manufacturer can accept a recycle content syngas or recycle content purified hydrogen composition, and either:
   i. apply at least a portion of the recycle credit to ammonia or
   ii. deposit at least a portion of the recycle content as a credit into a recycle content inventory, and either retain it in the inventory or apply at least a portion of the credit to ammonia.

As used herein, “recycle inventory” and “inventory” mean a group or collection of credits from which deposits and deductions of credits in any units can be tracked. The inventory can be in any form (electronic or paper), using any or multiple software programs, or using a variety of modules or applications that together as a whole tracks the deposits and deductions. Desirably, the total amount of recycle content withdrawn does not exceed the total amount of recycle content allotments or credits on deposit in the recycle inventory. However, if a deficit of recycle content value is realized, the recycle content inventory is rebalanced to achieve a zero or positive recycle content value available. The timing for rebalancing can be either determined and managed in accordance with the rules of a particular system of accreditation adopted by the manufacturer or by one among its Family of Entities, or alternatively, is rebalanced within 1.5 years, within one (1) year, or within six (6) months, or within three (3) months, or within one (1) month of realizing the deficit.

The timing for withdrawing a recycle content value from MPW or pyrolysis product and depositing it into the recycle inventory, applying a credit to a composition, and subjecting the MPW or pyrolysis product to molecular reforming (steam reforming or POX gasification), need not be simultaneous or in any particular order. In one embodiment, a recycle content value (or credit) is withdrawn from a MPW or pyrolysis product when the MPW or pyrolysis product is owned by, in the possession of, or in the inventory of a manufacturer of syngas, and optionally deposited into a recycle content inventory. This can occur before the MPW or pyrolysis product is processed in molecular reforming. In one embodiment, the step of molecular reforming a particular volume of MPW or pyrolysis product occurs after the recycle content value or credit from the MPW or pyrolysis product is deposited into a recycle inventory. Further, the credit values withdrawn from the recycle inventory need not be traceable to the MPW or pyrolysis product, but rather can be obtained from any waste recycle stream, and from any method of processing the recycle waste stream. Desirably, at least a portion of the recycle content value in the recycle inventory is obtained from MPW or pyrolysis product, and optionally at least a portion of MPW or pyrolysis product are processed in the one or more molecular reforming processes as described herein, optionally within a year of each other and optionally at least a portion of the volume of recycle MPW from which a recycle content value is deposited into the recycle inventory is also processed by any or more of the molecular reforming processes described herein.

Both the symmetric distribution and the asymmetric distribution of recycle content can be proportional on a Site wide basis, or on a multi-Site basis. In one embodiment or in combination with any of the mentioned embodiments, the recycle content input can be within a Site, and recycle content values from said inputs are applied to one or more compositions made at the same Site to make Recycle PIA. The recycle content values can be applied symmetrically or asymmetrically to one or more different compositions made at the Site.

In one embodiment or in combination with any of the mentioned embodiments, the recycle content input or creation (recycle content feedstock or allotments) can be to or at a first Site, and recycle content values from said inputs are transferred to a second Site and applied to one or more compositions made at a second Site. The recycle content values can be applied symmetrically or asymmetrically to the compositions at the second Site.

In an embodiment, the recycle content syngas, or recycle content purified hydrogen stream, or recycle content ammonia has associated with it, or contains, or is labelled, advertised, or certified as containing recycle content in an amount of at least 0.01 wt. %, or at least 0.05 wt. %, or at least 0.1 wt. %, or at least 0.5 wt. %, or at least 0.75 wt. %, or at least 1 wt. %, or at least 1.25 wt. %, or at least 1.5 wt. %, or at least 1.75 wt. %, or at least 2 wt. %, or at least 2.25 wt. %, or at least 2.5 wt. %, or at least 2.75 wt. %, or at least 3 wt. %, or at least 3.5 wt. %, or at least 4 wt. %, or at least 4.5 wt. %, or at least 5 wt. %, or at least 6 wt. %, or at least 7 wt. %, or at least 10 wt. %, or at least 15 wt. %, or at least 20 wt. %, or at least 25 wt. %, or at least 30 wt. %, or at least 35 wt. %, or at least 40 wt. %, or at least 45 wt. %, or at least 50 wt. %, or at least 55 wt. %, or at least 60 wt. %, or at least 65 wt. % and/or the amount can be up to 100 wt. %, or up to 95 wt. %, or up to 90 wt. %, or up to 80 wt. %, or up to 70 wt. %, or up to 60 wt. %, or up to 50 wt. %, or up to 40 wt. %, or up to 30 wt. %, or up to 25 wt. %, or up to 22 wt. %, or up to 20 wt. %, or up to 18 wt. %, or up to 16 wt. %, or up to 15 wt. %, or up to 14 wt. %, or up to 13 wt. %, or up to 11 wt. %, or up to 10 wt. %, or up to 8 wt. %, or up to 6 wt. %, or up to 5 wt. %, or up to 4 wt. %, or up to 3 wt. %, or up to 2 wt. %, or up to 1 wt. %, or up to 0.9 wt. %, or up to 0.8 wt. %, or up to 0.7 wt. %. The recycle content associated with the syngas, purified hydrogen stream, or ammonia can be associated by applying a credit to any of these compositions. The credit can be contained in the recycle content inventory created, maintained or operated by or for a manufacturer of any one of these compositions. The credit applied to the composition can be obtained from any source along any manufacturing chain of intermediate compositions or from the MPW or r-pyrolysis products themselves.

In an embodiment, there is provided a recycle hydrogen stream that can have associated with it, or contains, or is labelled, advertised, or certified as containing recycle content in an amount of at least 0.01 wt. %, or at least 10 wt. %, or at least 20 wt. %, or at least 30 wt. %, or at least 40 wt. %, or at least 50 wt. %, or at least 60 wt. %, or at least 70 wt. %, and in addition or in the alternative, up to 100 wt. %, or up to 95 wt. %, or up to 90 wt. %, or up to 80 wt. %, or up to 70 wt. %, or up to 60 wt. %, based on the weight of the hydrogen stream.

In an embodiment, the recycle content ammonia has associated with it, or contains, or is labelled, advertised, or certified as containing recycle content in an amount of at least 0.01 wt. %, or at least 0.05 wt. %. Additionally or in the alternative, the recycle content ammonia can have associated with it, or contains, or is labelled, advertised, or certified as containing recycle content up to 18%, or up to 17.75%, or up 12%, or up to 6%.

There is also provided a stream of hydrogen and a recycle content label, advertisement, documentation, or certificate (collectively a “certificate”). The certificate can be associated with the stream of hydrogen and need not be in physical contact or proximity with the hydrogen stream. The certificate can be provided to a customer of the hydrogen stream. The certificate contains a description of the level of recycle content associated with or applied to the hydrogen stream. The certificate can be confirmed or provided under or consistent with a certification obtained by a certification agency. The certificate can be provided to a customer of the hydrogen stream. The certificate contains a description of the level of recycle content associated with or applied to the hydrogen stream.

There is also provided a quantity of ammonia and a recycle content certificate. The certificate can be associated with the stream of ammonia and need not be in physical contact or proximity with the ammonia composition. The certificate can be provided to a customer of the ammonia stream. The certificate contains a description of the level of recycle content associated with or applied to the ammonia composition. The certificate can be confirmed or provided under or consistent with a certification obtained by a certification agency. The certificate can be provided to a customer of the ammonia composition. The certificate contains a description of the level of recycle content associated with or applied to the ammonia composition.

In one embodiment, the ammonia manufacturer can make recycle ammonia, whether or not a purified hydrogen stream has a recycle content value, and either:
i. from the supplier of the purified hydrogen stream, obtain a recycle content credit applied to the purified hydrogen stream, or
ii. from any person or entity, such as a syngas producer or pyrolysis product manufacturer, obtain a recycle content credit whether or not the purified hydrogen stream is associated with a recycle content value.

The syngas stream manufacturer, which optionally may be in the same Family of Entities as the ammonia manufacturer, may:
a. deposit the credit into an inventory and merely store it; or
b. deposit the credit into an inventory and apply credits from the inventory to products other than:
   i. any products derived directly or indirectly from a syngas stream, or
   ii. to chemical compounds or polymers made by the manufacturer, or
c. sell or transfer an allocation from the inventory into which at least one allotment, obtained as noted above, was deposited,
d. deposit the credit into a recycle content inventory and apply a credit from the inventory to either the syngas, purified hydrogen stream, or ammonia.

In one embodiment, the ammonia manufacturer obtains a supply of purified hydrogen from a supplier, and also obtains a recycle content credit from the supplier, where such credit is derived from MPW or r-pyrolysis products or from molecular reforming of MPW or r-pyrolysis products, and optionally the credit is associated with the purified hydrogen composition or stream supplied by the supplier. At least a portion of the credit obtained by the ammonia manufacturer or in the possession of the ammonia manufacturer is either:
a. applied to ammonia composition that is physically made by the recycle content purified hydrogen stream obtained from the supplier;
b. applied to an ammonia composition that is not made by the recycle content purified hydrogen stream obtained from the supplier, such as would be the case when a credit from the recycle content purified hydrogen stream is deposited into a recycle content inventory, and a credit from the inventory is withdrawn and associated to an inventory of ammonia not made with the particular recycle content purified hydrogen supplied, such as would be the case if there is pre-existing ammonia inventory or future ammonia inventory, or
c. deposited into an inventory and stored.

The syngas manufacturing facility can make ammonia. In this system, the syngas manufacturing facility can have its output in fluid communication with the ammonia manufacturing facility. The fluid communication can be gaseous or liquid or both. The fluid communication need not be continuous and can be interrupted by storage tanks, valves, or other purification or treatment facilities, so long as the fluid can be transported from the manufacturing facility to the subsequent facility through an interconnecting pipe network and without the use of truck, train, ship, or airplane. Further, the facilities may share the same site, or in other words, one site may contain two or more of the facilities. Additionally, the facilities may also share storage tank sites, or storage tanks for ancillary chemicals, or may also share utilities, steam or other heat sources, etc., yet also be considered as discrete facilities since their unit operations are separate. A facility will typically be bounded by a battery limit.

In one embodiment, the integrated process includes at least two facilities co-located within 5, or within 3, or within 2, or within 1 mile of each other (measured as a straight line). In one embodiment, at least two facilities are owned by the same Family of Entities. The at least two facilities can be any combination of a syngas facility, a hydrogen purification facility, and/or an ammonia synthesis facility.

The recycle content ammonia can be used as a raw material to make urea and ammonium salts such as ammonium phosphates, ammonium nitrates, calcium ammonium nitrates any one of which are useful for the production of fertilizers, and in the production of wood pulp, in the production of nitric acid, in the production of polyamides, and as solutions of ammonia for hard surface cleaning. The recycle content ammonia can be reacted with carbon dioxide to make a recycle content urea.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “partial oxidation (POX)” or “POX” refers to high temperature conversion of a carbon-containing feed into syngas, (carbon monoxide, hydrogen, and carbon dioxide), where the conversion is carried out in the presence of a less than stoichiometric amount of oxygen. The feed to POX gasification can include solids, liquids, and/or gases.

As used herein, the phrase “pyoil” or “pygas” or “pyrolysis products” are interchangeable with “r-pyoil” or “r-pygas” or “r-pyrolysis products” since the pyoil and pygas and pyrolysis products as used herein are obtained at least in part through pyrolysis of MPW.

As used herein, the phrase “MPW” includes a composition or stream or feedstock of mixed plastic waste or compositionally uniform or similar compositions of plastic streams that have been separated from MPW.

1. A process for making recycle content ammonia comprising reacting hydrogen with nitrogen, wherein at least a portion of said hydrogen is obtained directly or indirectly by molecular reforming of a feedstock comprising mixed plastic waste (“MPW”), a pyrolysis product, or a combination thereof.

2. The process of claim 1, wherein the molecular reforming comprises steam reforming of methane obtained from said feedstock.

3. The process of claim 2, wherein said feedstock comprises a petroleum naphtha and a pyrolysis product.

4. The process of claim 3, wherein the pyrolysis product comprises r-pyoil obtained by pyrolyzing MPW.

5. The process of claim 1, wherein said hydrogen enriched stream is subjected to one or more processes to remove or convert carbon oxides to produce a purified hydrogen stream.

6. The process of claim 4, wherein at least a portion of said purified hydrogen stream is physically obtained from syngas made by steam reforming methane obtained from a feedstock comprising MPW.

7. The process of claim 1, wherein at least a portion of the purified hydrogen stream contains recycle content through application of a recycle content credit from a recycle content inventory, said recycle content inventory containing recycle credits at least a portion of which are obtained from receiving or processing MPW or a pyrolysis product.

8. The process of claim 1, wherein the ammonia contains recycle content through application of a recycle content credit from a recycle content inventory, said recycle content inventory containing recycle credits at least a portion of which are obtained from receiving or processing MPW, a pyrolysis product, or a recycle content purified hydrogen stream.

9. The process of claim 1, comprising:
a) receiving MPW or r-pyoil obtained from MPW,
b) depositing a recycle content credit from said MPW or r-pyoil into a recycle content inventory,
c) making syngas through a steam reforming process,
d) reacting hydrogen in said syngas with nitrogen to make ammonia; and
e) applying a recycle content credit to said ammonia obtained from the recycle content inventory.

10. The process of claim 1, wherein the molecular reforming comprises partial oxidation of said feedstock to make syngas.

11. The process of claim 10, wherein the feedstock further comprises a solid fossil fuel.

12. The process of claim 10, wherein the feedstock comprises MPW.

13. The process claim 10, wherein at least a portion of hydrogen reacted with nitrogen to make ammonia is physically obtained from syngas made by partial oxidation of a feedstock comprising mixed plastic waste and coal.

14. The process of claim 10, wherein said syngas stream is reacted with steam in a shift reactor to convert at least a portion of carbon monoxide and water to carbon dioxide and hydrogen to generate a hydrogen enriched stream.

15. The process of claim 10, comprising:
a) receiving MPW,
b) depositing a recycle content credit from said MPW into a recycle content inventory,
c) making syngas through partial oxidation gasifier,
d) reacting hydrogen in said syngas with nitrogen to make ammonia; and
e) applying a recycle content credit to said ammonia obtained from the recycle content inventory.

16. The process of claim 1, wherein said nitrogen comprises a stream of separated nitrogen.

17. A stream of hydrogen and a recycle content certificate.

18. Ammonia and a recycle content certificate.

19. (canceled)

20. (canceled)
